(19) United States
(12) Patent Application Publication
(10) Pub. No.: US 2024/0023494 A1
(43) Pub. Date: Jan. 25, 2024

(54) MODULAR LIVING WALL SYSTEM

(71) Applicants: David Brenner, Albany, CA (US); Michael Carson Mangan, El Cerrito, CA (US)

(72) Inventors: David Brenner, Albany, CA (US); Michael Carson Mangan, El Cerrito, CA (US)

(21) Appl. No.: 18/206,779

(22) Filed: Jun. 7, 2023

Related U.S. Application Data
(63) Continuation-in-part of application No. 17/869,112, filed on Jul. 20, 2022.

(51) Int. Cl. A01G 9/02

(52) U.S. Cl. CPC A01G 9/025

(57) ABSTRACT

The invention pertains to a modular living wall system for facilitating plant growth on a structural wall of a building. The system includes a number of attachment channels fastened to the structural wall and at least one growing module. Each growing module comprises a growing cage configured to retain at least two growing substrates, with each substrate facilitating the growth of plants. A key feature of the system is the capillary break between each growing substrate, formed by the structure of the growing cage. This capillary break aids in managing water movement and helps maintain an optimal growing environment. The growing module is designed to connect to the attachment channels, forming the modular living wall system. Additional features can include a waterproof membrane, a growing sleeve surrounding the growing module, and a facade panel with openings to display the vegetation. This inventive system offers a versatile and efficient method for incorporating greenery into built environments.

### CROSS-REFERENCE TO RELATED APPLICATIONS

The present invention is a continuation in part application to United States Non-provisional application Ser. No. 17/869,112 filed Jul. 20, 2022, which is hereby incorporated in its entirety at least by reference.

### BACKGROUND OF THE INVENTION

### 1. Field of the Invention

The present invention relates generally to horticulture but more particularly to a living wall system.

### 2. Description of Related Art

Living walls, sometimes called green walls or vertical gardens, are vertically built structures configured to hold vegetation. While living walls have a great aesthetic appeal, they also provide good insulation to reduce the temperature of the building in which the living wall is installed. This makes living walls popular in urban environments. When installed indoors, living walls can improve air quality, climate, noise levels, and reduce CO₂.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

It is a main object of the present disclosure to provide a living wall system configured to move water evenly throughout the system. It is another object of the invention to provide a living wall system maximizing water holding capacity and limiting runoff. It is another object of the invention to provide a scalable modular system that is easy to install, secure, and attach to wall structures. It is yet another object of the invention it utilize non-combustible materials to provide a high fire rating. It is yet another object of the invention it provide pre-grown plant modules or pre-seeded assemblies.

In order to do so, embodiments of the present disclosure comprise a modular living wall system having a number of attachment channels configured to be fastened to a structural wall of a building; at least one growing module, each growing module including a growing cage configured to retain at least two growing substrates, wherein each growing substrate may be configured to facilitate the growth of plants; a capillary break between each growing substrate formed by the structure of the growing cage; and, the at least one growing module configured to connect to the number of attachment channels to form the modular living wall system.

In some embodiments, each growing substrate may be constructed from rockwool. In some embodiments, the growing cage may be constructed from stainless steel rods, and the capillary break may be formed via a double rod assembly. In some embodiments, teach growing substrate includes openings configured to receive soil pockets or plant material.

In some embodiments, the modular living wall system may include a growing sleeve surrounding the at least one growing module. In some embodiments, each growing substrate includes a number of plant seeds distributed throughout the growing substrate. In some embodiments, the modular living wall system may include a facade panel having a number of openings at various geometries. In some embodiments, the number of openings may be configured to allow the growth of plants from the number of seeds to be visible or extend outside the facade panel.

In some embodiments, the at least one growing module may be wrapped in a growing fabric having perforations configured to receive a number of plant seeds. In some embodiments, the modular living wall system may include a facade panel having a number of openings at various geometries. In some embodiments, the number of openings may be configured to allow the growth of plants from the number of seeds to be visible or extend outside the facade panel. In some embodiments, the modular living wall system may include a waterproof membrane positioned directly between the at least one growing module and the structural wall.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a perspective view of a first living wall system according to an embodiment of the present invention.

FIG. 2 is an exploded view showing the assembly of the first living wall system according to an embodiment of the present invention.

FIG. 3 is an exploded view showing the composition of the first living wall system according to an embodiment of the present invention.

FIG. 4 show various channel types which may be utilized by the system according to an embodiment of the present invention.

FIG. 5A is a perspective view of the growing cage configured to hold the growing substrate according to an embodiment of the present invention.

FIG. 5B is a detailed view of FIG. 5A.

FIG. 5C is a perspective view of the growing cage including two growing substrate modules according to an embodiment of the present invention.

FIG. 6A is a right perspective view of the growing substrate according to an embodiment of the present invention.

FIG. 6B is a left perspective transparent view of the growing substrate according to an embodiment of the present invention.

FIG. 7 is a perspective view of a second living wall system according to an embodiment of the present invention.

FIG. 8 is an exploded view showing the composition of the second living wall system according to an embodiment of the present invention.

FIG. 9A is a perspective view of the facade according to an embodiment of the present invention.

FIG. 9B is a detailed view of FIG. 9A.

FIG. 9C is a detailed view of FIG. 9B showing plant growth.

FIG. 10A is a perspective view of a growing module consisting of a cage and growing substrate provided in the second living wall system according to an embodiment of the present invention.

FIG. 10B is a detailed view of FIG. 10A.

FIG. 11 is a perspective view of an alternative growing module according to an embodiment of the present invention.

### DETAILED DESCRIPTION OF THE INVENTION

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide a living wall system.

It is to be understood that the terminology used herein is for the purpose of describing particular embodiments only and is not intended to be limiting. The terms “a” or “an,” as used herein, are defined as to mean “at least one.” The term “plurality,” as used herein, is defined as two or more. The term “another,” as used herein, is defined as at least a second or more. The terms “including” and/or “having,” as used herein, are defined as comprising (i.e., open language). The term “coupled,” as used herein, is defined as connected, although not necessarily directly, not necessarily mechanically, and not permanent. The term “providing” is defined herein in its broadest sense, e.g., bringing/coming into physical existence, making available, and/or supplying to someone or something, in whole or in multiple parts at once or over a period of time. As used herein, the terms “about,” “generally,” or “approximately,” apply to all numeric values, whether or not explicitly indicated. These terms generally refer to a range of numbers that one of skill in the art would consider near the stated amount by about 0%, 5%, or 10%, including increments therein. In many instances these terms may include numbers that are rounded to the nearest significant figure.

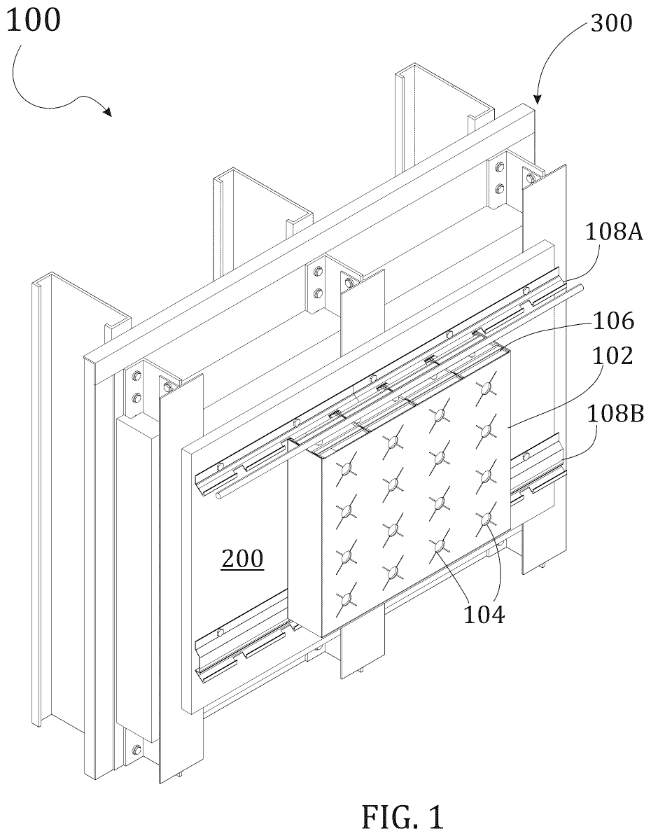

FIGS. 1-3 are various views of the living wall according to an embodiment of the present invention. Referring now to FIGS. 1-3, the living wall system 100 is illustrated. In one embodiment, the living wall is configured to be attached to a wall of a building 300 or other structure. A waterproofing membrane layer 200 is directly attached to the wall, preventing the wall from moisture during use. In one embodiment, waterproofing membrane layer 200 is a self-adhesive rubberized asphalt/polyethylene waterproofing membrane, such as Bituthene© 3000. In some embodiments, depending on the wall type, the waterproof membrane may not be necessary. Next, in some embodiments, a number of channels are used 108, wherein the channels are attached to the wall or structure 300 and are configured to attach one or more growing modules to the wall. This will be discussed in greater detail below. In some embodiments, a number of screws 120 are used for securing the channels 108 to the wall 300.

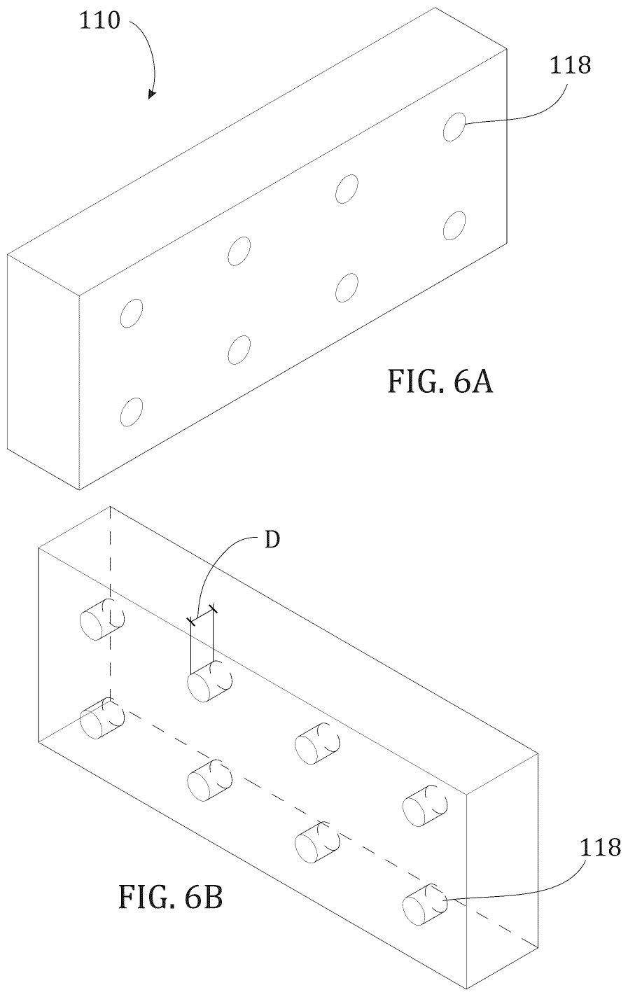

Still referring to FIGS. 1-3, a growing module consists of growing cage 106, growing substrate 110, and a growing sleeve 102. The growing cage is configured to hold one or more module growing substrate elements 110, which is then covered by a growing sleeve. In one embodiment, the growing sleeve is a non-combustible cover allowing for moss and byrophytes to establish on the face of the system while also securing the rockwool growing substrate and other components within the growing module. In some embodiments, the non-combustible cover is constructed of carbonized fiber or similar material. In some embodiments, a number of soil pockets 114 are configured to be inserted into the openings (118; FIGS. 6A-B) of the growing substrate 110. In one embodiment, the growing substrate is constructed from rockwool. Plants 116 either provide as plugs, cuttings, semi-mature plants, grown plants, or seeds are positioned within the number of soil pockets 114. Finally, irrigation lines 112 having drip emitters are provided at the top of the system to provide irrigation to the living wall system such that appropriate levels of saturation can be maintained.

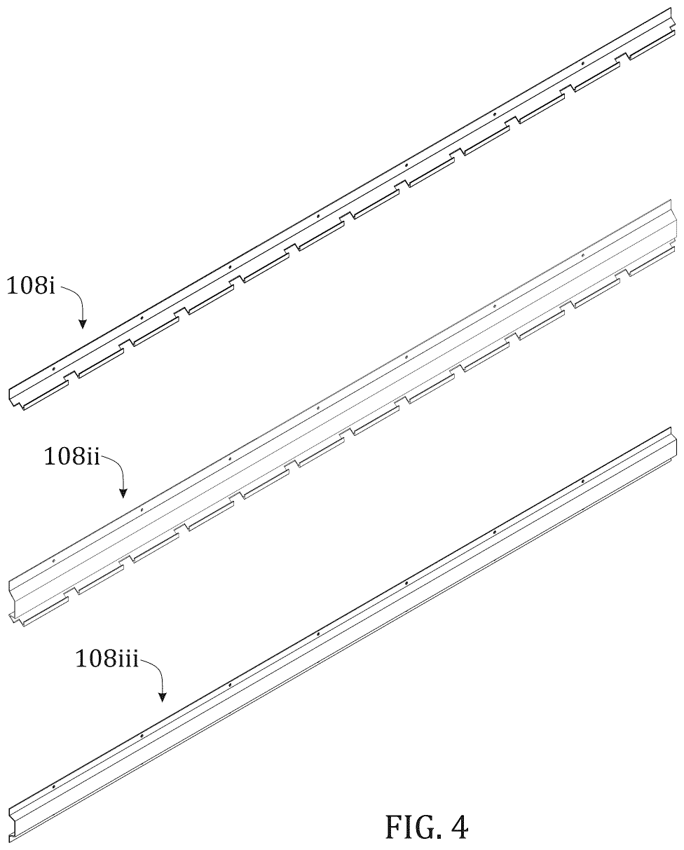

Referring now to FIG. 4, various channel types are shown. Advantageously, a fully assembled grow module may be attached or connected to one or more channels secured to the wall. In some embodiments, the channels are constructed from 16 gauge stainless steel, and usually 10 feet in length, but it is understood the size may vary. In some embodiments, an “L” clip channel 108i is positioned along the entire top portion or row of the living wall system. In some embodiments, a clip channel 108ii is positioned in every other proceeding row between the top and bottom rows of the living wall system. Finally, in some embodiments, a hat channel 108iii is positioned along the entire bottom row for every living wall application. Advantageously, the grow modules may be tilted, dropped, and set into the channels for easy installation.

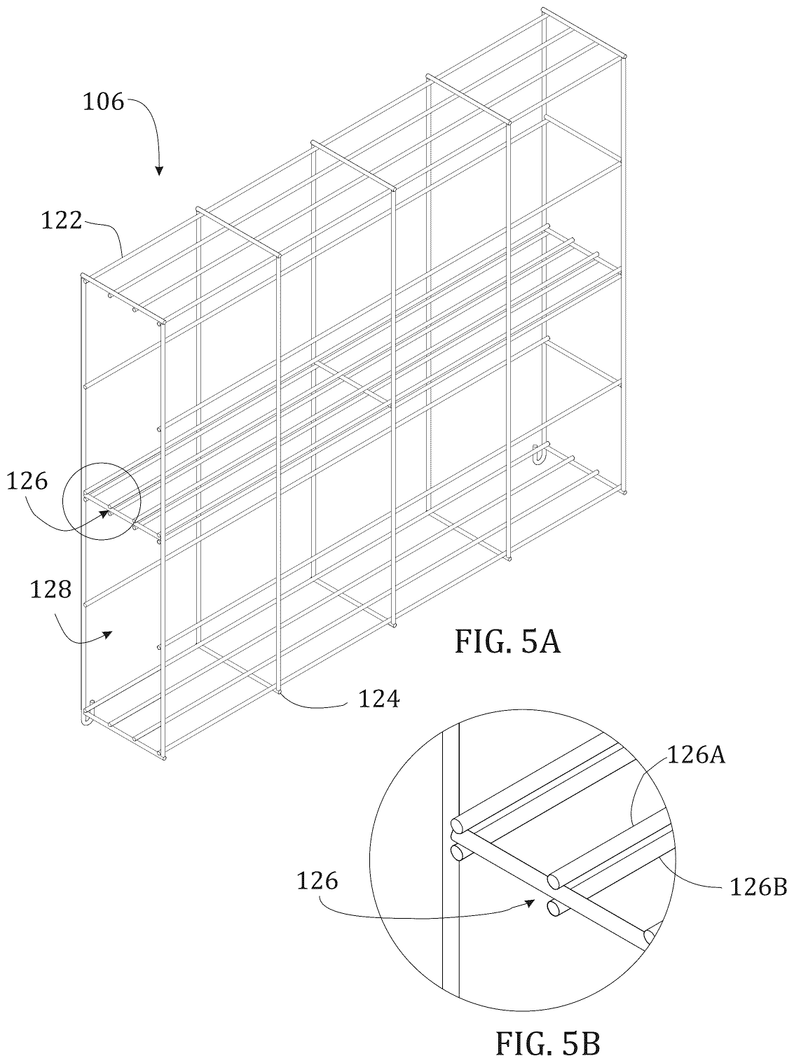

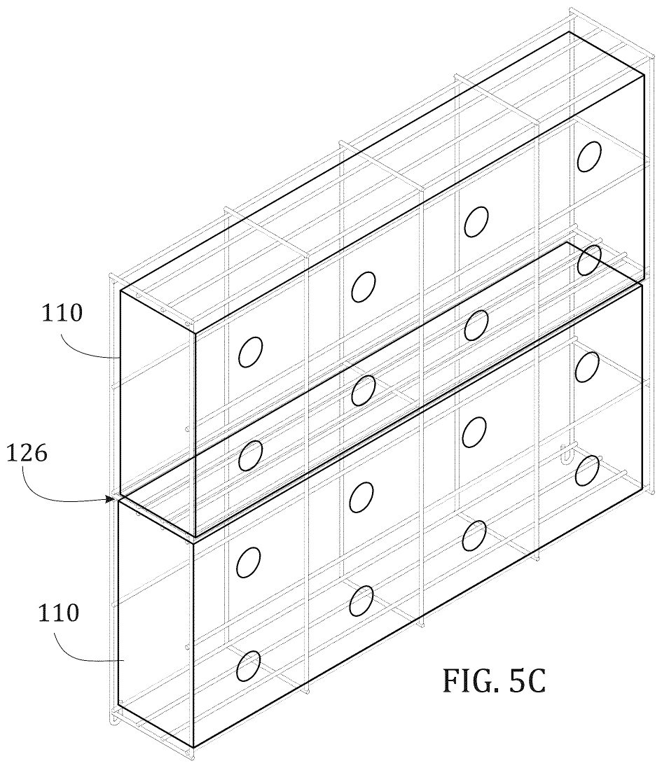

Referring now to FIGS. 5A-C, a perspective view of the growing cage 106 is illustrated. In some embodiments, the growing cage is constructed from ⅛″ steel stainless steel rods 122. Structural cross-rods 124 are provided to enclose and support the growing substrate modules 110 within the growing cage. It is a particular advantage of the present invention to provide a capillary gap 126 between growing substrate modules, wherein the capillary break is created by a specific arrangement of the rod construction. In one embodiment, the arrangement of rods may be defined as a double rod assembly 126A and 126B providing the capillary (best seen in FIG. 5B). In some embodiments, the rod spacing provides a ⅜″ capillary gap, but the distance of the gap may vary. Advantageously, the capillary break 126 provides and prevents the movement of water within the system at the capillary break to stop the capillary action as well known in the art. The capillary break helps to prevent excess water from running off the living wall system, and ensures even and adequate water distribution throughout the growing substrate to ensure proper hydration of the plants.

The capillary break, or capillary gap, is a critical feature of this living wall system, performing a crucial role in managing water distribution within the growing substrate modules. The capillary break, created by rod spacing that provides a gap of around 3/8″ (though this distance can vary), interrupts the natural capillary action that would otherwise draw water consistently upward through the growing substrates, opposing the force of gravity. This is particularly important in a vertical gardening system such as a living wall, where gravity naturally pulls water downward. Without the capillary break, capillary action could lead to an unequal distribution of moisture, with excess water accumulating in the upper sections and potentially depriving the lower portions of sufficient moisture. The capillary break halts this continuous capillary action, ensuring that water does not excessively accumulate in the upper portions of the wall and that the lower sections receive adequate moisture. Therefore, the capillary break plays a crucial role in maintaining an even water distribution throughout the living wall, promoting healthy and uniform plant growth across the entire surface. This also aids in preventing excess water from running off the system, reducing water waste and contributing to the overall efficiency and sustainability of the living wall.

Referring now to FIGS. 6A-B, a detail of a single growing substrate module 110 is

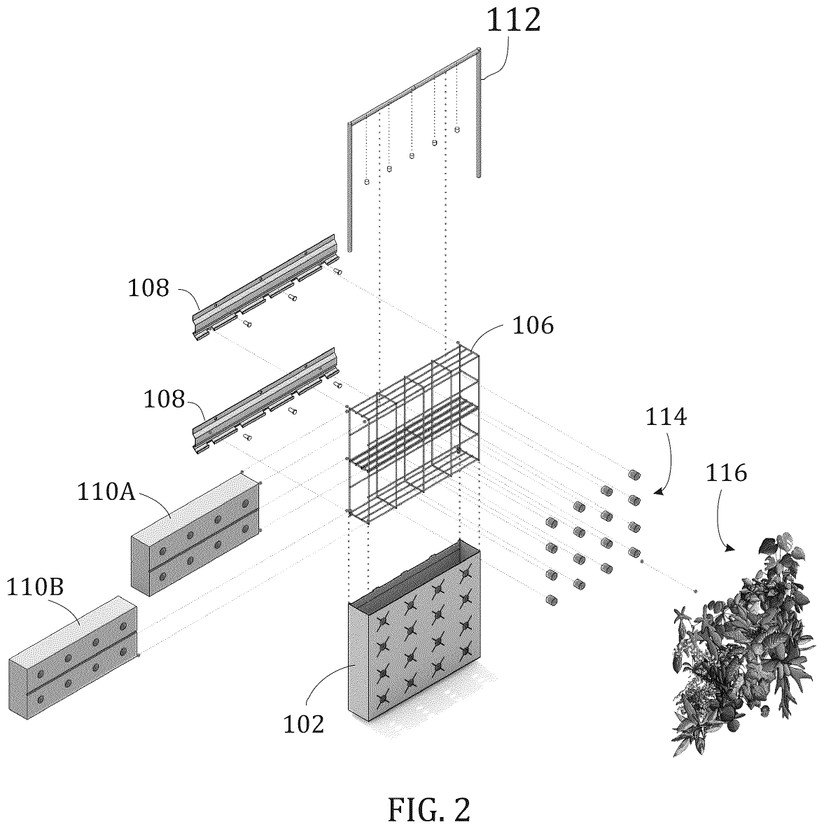

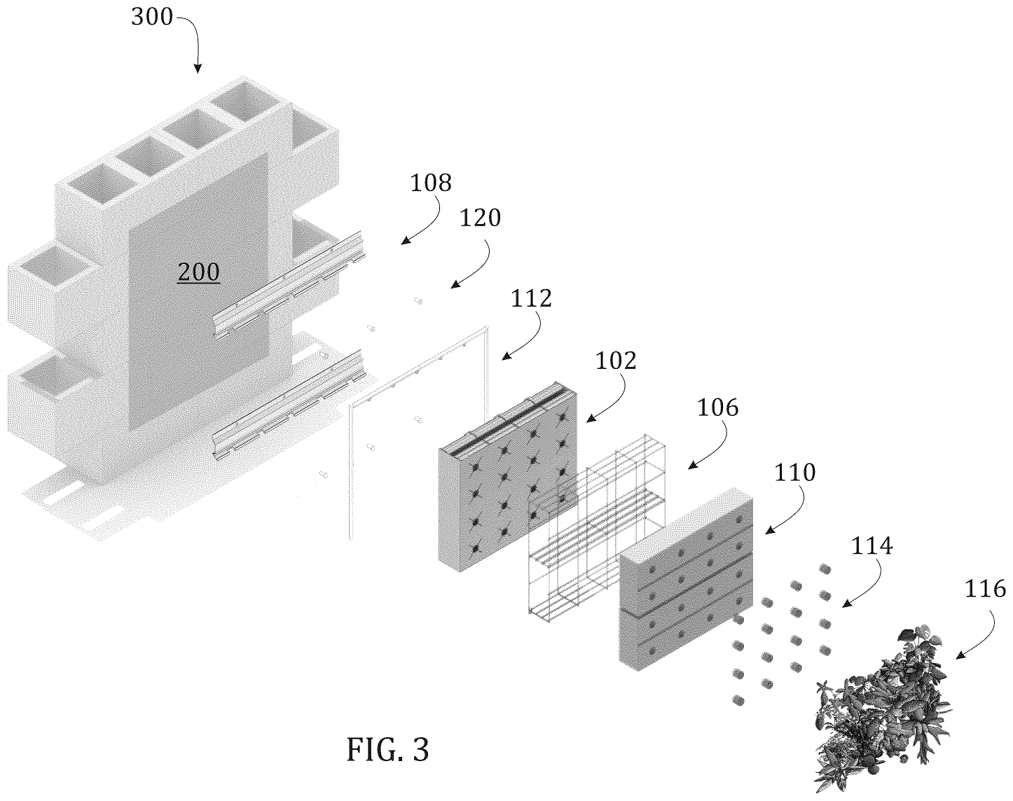

illustrated. In one embodiment, the growing substrate module is rectangular, and is constructed from rockwool. In one embodiment, the rockwool is a 100 density rockwool (100 kilograms per cubic meter). In each single growing substrate module 110 two rows of penetrations or openings 118 are provided, wherein the depth of the opening is approximately 1″. In some embodiments, the openings are approximately 1″ in diameter. In some embodiments, the living wall system, or more specifically the growing cage is configured to retain two growing substrate modules, such as seen in FIG. 5C. The openings are configured to receive soil pockets (114; FIGS. 2-3) or plant material as previously discussed. Although, openings are shown, in alternative embodiments, a pre-seeded growing substrate may be provided.

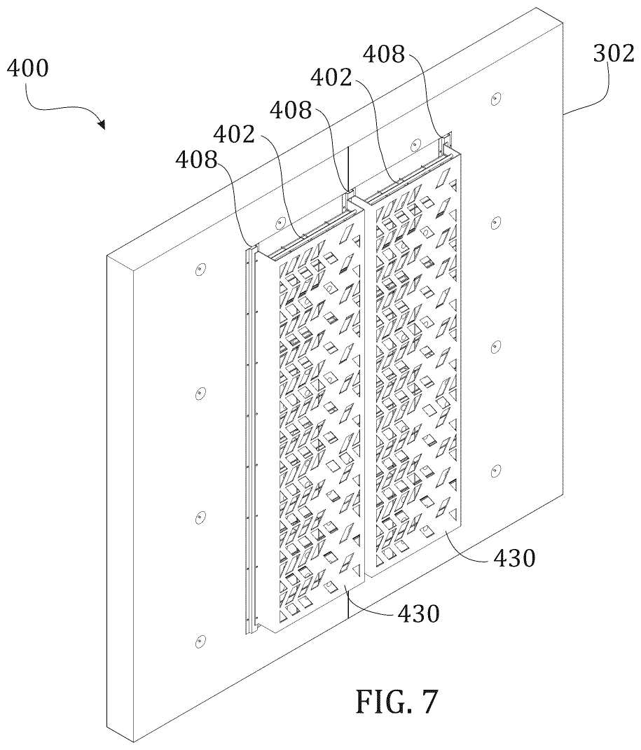

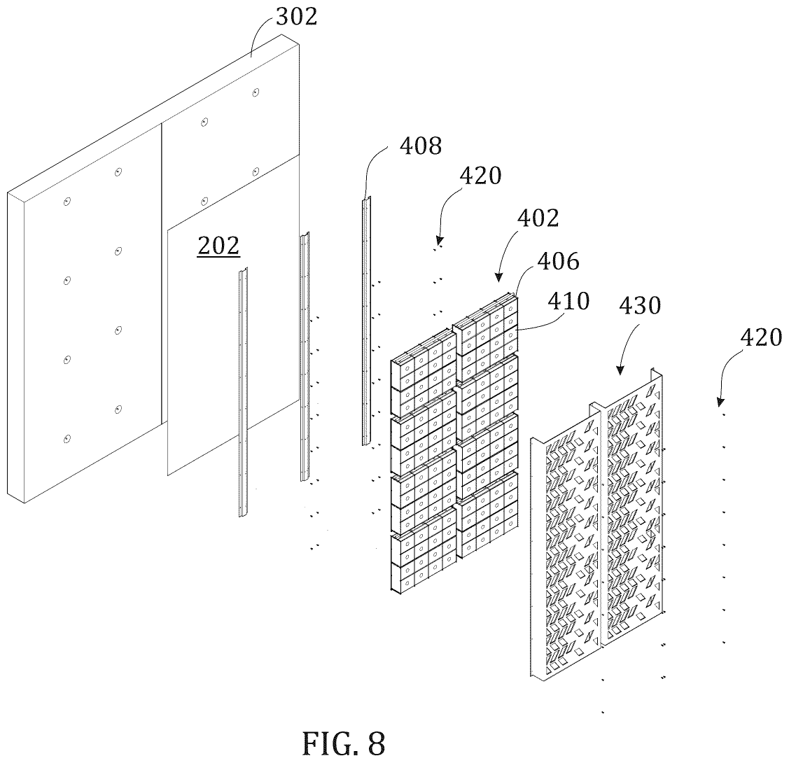

Referring now to FIGS. 7-8, a second or alternate living wall system 400 is illustrated. Similarly as the first living walls system, the second living wall system 400 is configured to attach to a structural wall 302 via number of channels 408. In one embodiment, hat channels are provided. Typically, a waterproof membrane 202 is used between the wall 302 and the living wall system 400, however, ultimately it depends on the wall type and construction. In some embodiments, applicable screws 420 are used to secure the number of channels 408 to the wall. Next, a number of growing modules 402 are provided, wherein the composition of each growing module 402 is as previously disclosed. More specifically, each growing module includes a growing cage 406 and two growing substrate modules 410. Advantageously, in this embodiment, a facade panel 430 is provided, wherein the facade panel provides the ability to customize the external look and design of the living wall. Again, applicable screws 420 are provided to secure the facade panel 430 to the assembly. Irrigation (not illustrated) is provided as previously discussed. Further, each growing module includes the advantageous capillary break system as previous discussed.

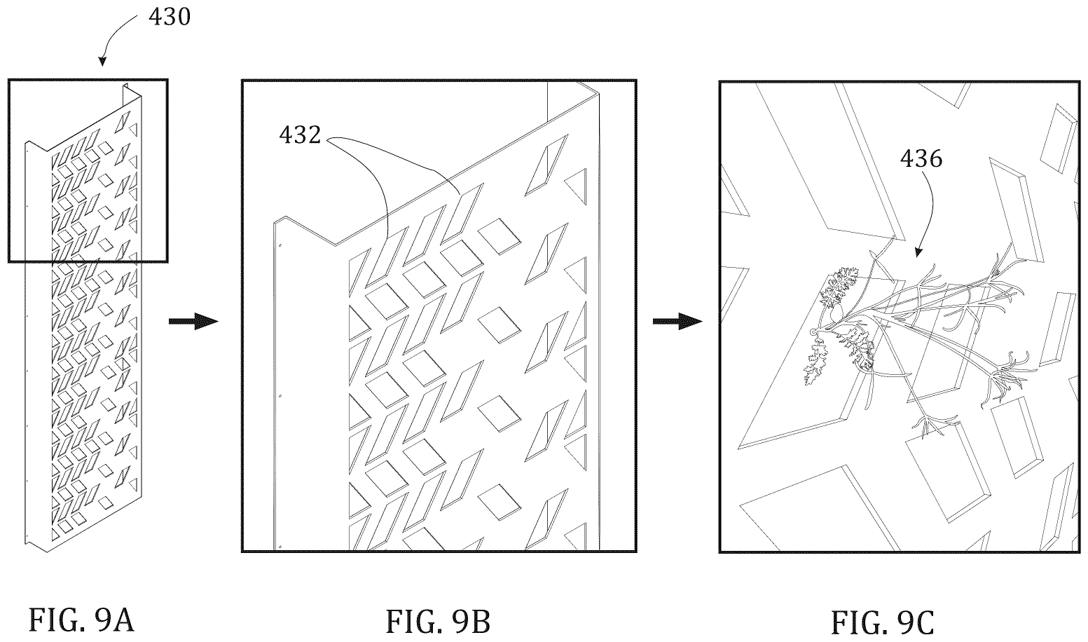

Referring now to FIGS. 9A-C, the details of the facade panel 430 is illustrated. In some embodiments, the facade panel has a plurality of openings 432 of various geometry. The geometry of the facade panel may vary depending on the selected plant varieties and the desired output or look the owner would like to achieve. The second living wall 400 is configured to be used with seeds, wherein the seeds sprout and are configured to conform to the customized aesthetics and geometry provided on the panel. The seeds are provided on the growing module which will be discussed in greater details below. In some embodiments, the facade panel 430 is constructed from stainless steel, and is configured to overlap and cover the growing modules of the living wall system. The number of openings, angles, locations, etc. of the facade panel may vary depending on the desired vegetation type, density, and appearance desired when the plant matter 436 is matured.

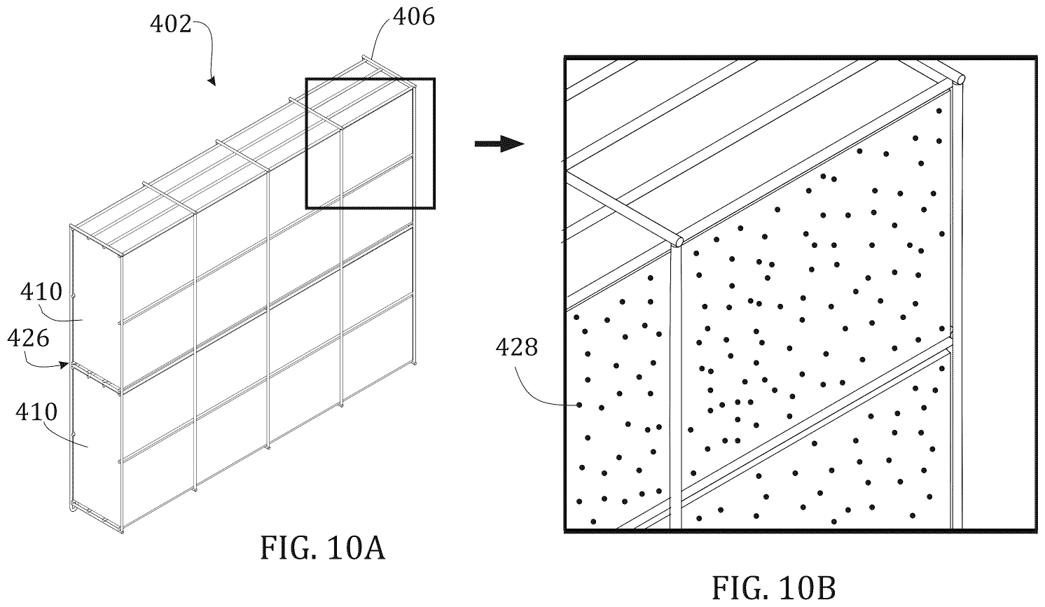

Referring now to FIGS. 10A-B, a growing module 402 is illustrated. In one embodiment, the growing module 402 includes a growing cage 406 and two growing substrates 410 separated by a capillary break 426 by previously disclosed means, such as the gap or spacing between rod assemblies. In one embodiment, the growing substrate 410 is constructed from rockwool. In this embodiment, seeds 428 are evenly distributed throughout the entirety of each module/growing substrate. Ultimately, the seed type, distribution, etc. may vary depending on desired outputs in related to the custom facade panel used for the living wall system.

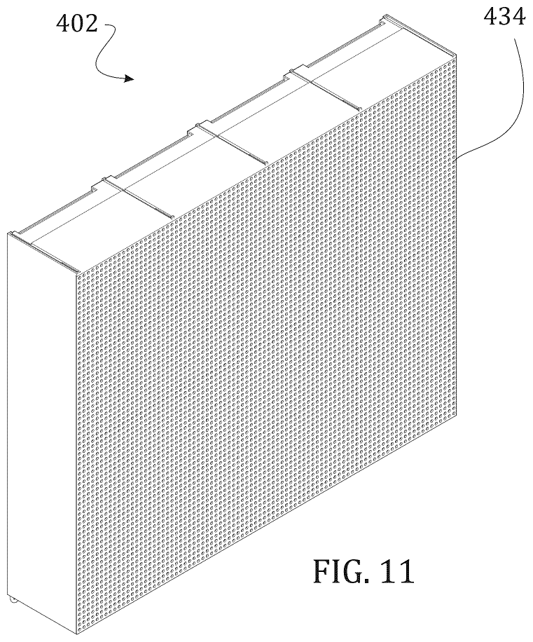

FIG. 11 shows an alternate embodiment, where the growing module 402 is wrapped in a growing fabric 434 for facilitating seedling growth. More specifically, the growing fabric 434 includes a number of needle-punch perforation that are configured to hold seeds. In some embodiments, a biodegradable glue is used to keep the seeds in place. In one embodiment, each perforation is approximately 1/16″. As previously, discussed, the facade panel is configured to cover the growing module during use, wherein the seed type, distribution, etc. may vary depending on desired outputs in related to the custom facade panel used for the living wall system.

It should be understood that the size of the living wall system may vary. Often, several growing modules are needed to meet the size requirement for a specific living wall installation.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

What is claimed is:

1. A modular living wall system comprising:
a number of attachment channels configured to be fastened to a structural wall of a building;
at least one growing module, each growing module comprising a growing cage configured to retain at least two growing substrates, wherein each growing substrate is configured to facilitate the growth of plants;
a capillary break between each growing substrate formed by the structure of the growing cage; and,
the at least one growing module configured to connect to the number of attachment channels to form the modular living wall system.

2. The modular living wall system of claim 1, wherein each growing substrate is constructed from rockwool.

3. The modular living wall system of claim 1, wherein the growing cage is constructed from stainless steel rods, and the capillary break is created by an arrangement of the stainless steel rods providing a gap between each growing substrate.

4. The modular living wall system of claim 1, wherein each growing substrate includes openings configured to receive either soil pockets or plant material.

5. The modular living wall system of claim 4, further comprising a growing sleeve surrounding the at least one growing module.

6. The modular living wall system of claim 1, wherein each growing substrate includes a number of plant seeds distributed throughout the growing substrate.

7. The modular living wall system of claim 1, wherein the at least one growing module is wrapped in a growing fabric having perforations configured to receive a number of plant seeds.

8. The modular living wall system of claim 6, further comprising a facade panel having a number of openings at various geometries, wherein the number of openings are configured to allow the growth of plants from the number of seeds to be visible or extend outside the facade panel.

9. The modular living wall system of claim 7, further comprising a facade panel having a number of openings at various geometries, wherein the number of openings are configured to allow the growth of plants from the number of seeds to be visible or extend outside the facade panel.

10. The modular living wall system of claim 1, further comprising a waterproof membrane positioned directly between the at least one growing module and the structural wall.
